(19) United States
(12) Patent Application Publication
(10) Pub. No.: US 2025/0145375 A1
(43) Pub. Date: May 8, 2025

(54) Goods Storage System and Method

(71) Applicant: Swisslog AG, Buchs (CH)

(72) Inventors: Felix Ruscheweyh, Dortmund (DE); Marc Rhode, Essen (DE)

(73) Assignee: Swisslog AG, Buchs (CH)

(21) Appl. No.: 18/938,751

(22) Filed: Nov. 6, 2024

(30) Foreign Application Priority Data
Nov. 7, 2023 (EP) 23208343.6

(51) Int. Cl. B65G 1/04

(52) U.S. Cl. CPC B65G 1/0492; B65G 1/0464

(57) ABSTRACT

A goods storage system includes, among other things, a goods repository with several lifting apparatuses without a drive arranged in storage shafts, wherein each lifting apparatus or a corresponding group of lifting apparatuses include a drive coupling which is designed to apply a drive torque to the lifting apparatus. The drive couplings are accessible from a driving level. The system further includes at least one driverless vehicle with a lifting drive and a drive mating coupling corresponding to the drive couplings of the lifting apparatuses. The drive mating coupling is designed for automatic coupling to one of the drive couplings of the lifting apparatuses when the driverless vehicle is located in couplable proximity to the corresponding drive coupling of the lifting apparatus.

### CROSS-REFERENCE TO RELATED APPLICATIONS

This application claims the benefit of priority under 35 U.S.C. § 119(a) to European Patent Application No. 23208343.6, filed Nov. 7, 2023, the disclosure of which is incorporated by reference herein in its entirety.

### TECHNICAL FIELD

The invention relates to a goods storage system with a goods repository that comprises a plurality of storage shafts arranged in a plurality of rows and columns directly next to one another such that each storage shaft is accessible via an upper shaft opening for removing one or more containers from the corresponding storage shaft from above, and/or for inserting one or more containers into the corresponding storage shaft from above so that a plurality of containers can be stored in a vertical stack within the corresponding storage shaft. The invention also relates to a method for lifting and/or lowering at least one container in a goods repository of a goods storage system.

### BACKGROUND

EP 3 820 791 B1 describes a storage system that comprises a plurality of vertical stacks of storage containers, wherein the stacks are arranged in a horizontal first direction and a horizontal second direction which is perpendicular to the first direction, a transport unit for transporting at least one container to or from a selected stack in the first and/or second direction, a container handling apparatus for transferring at least one upper container from a selected stack to the transport unit before the transport unit together with the container is transported from said selected stack, and for transferring at least one container from the transport unit to the upper end of a selected stack after the transport unit together with the container is transported to said selected stack, wherein the transport unit is movable above the stacks, wherein the container handling apparatus comprises a lifting element for displacing a selected stack in a vertical direction with respect to adjacent stacks, wherein the lifting element is movable below the stacks in a non-lifted state thereof, and wherein the container handling apparatus comprises an engagement element that is provided on the transport unit and is suitable to be engaged with at least one upper container of a lifted stack to retrieve said container or to release an engaged container in order to place said container on the upper end of a selected stack.

### SUMMARY

The object of the invention is to create a goods storage system and an associated method, whereby at least one container in a storage shaft of a goods repository of the goods storage system can be automatically lifted and/or lowered in a simple and reliable manner.

The object is achieved by a goods storage system, comprising:
a goods repository that comprises a plurality of storage shafts arranged in a plurality of rows and columns directly next to one another such that each storage shaft is accessible via an upper shaft opening for removing one or more containers from the corresponding storage shaft from above, and/or for inserting one or more containers into the corresponding storage shaft from above so that a plurality of containers can be stored in a vertical stack within the corresponding storage shaft,
a driving level arranged above the storage shafts, which comprises guides which are designed to drive a driverless vehicle within the driving level, optionally in a first driving direction, in order to be able to switch between a plurality of shaft openings of a plurality of storage shafts arranged in a row, and in a second driving direction in order to be able to switch between a plurality of shaft openings of a plurality of storage shafts arranged in a column,
at least one driverless vehicle which is designed and equipped to automatically drive in the driving level along the guides so that the driverless vehicle can be moved to the shaft opening of any storage shaft of the goods repository by the driverless vehicle driving in a self-driven manner optionally in the first driving direction and/or in the second driving direction along the guides,
a plurality of lifting apparatuses arranged on the goods repository, of which one lifting apparatus is designed to lift and lower at least one stack of a plurality of containers stored in a corresponding storage shaft, characterized in that

the plurality of lifting apparatuses are designed without a drive, and each lifting apparatus or a corresponding group of a plurality of lifting apparatuses comprises a drive coupling which is designed to inject a drive torque into the lifting apparatus, wherein the drive couplings are accessible from the driving level, and that
the at least one driverless vehicle comprises a lifting drive with a drive mating coupling corresponding to the drive couplings of the lifting apparatuses, which drive mating coupling is designed for automatic coupling to one of the drive couplings of the lifting apparatuses when the driverless vehicle is located in couplable proximity to the corresponding drive coupling of the lifting apparatus.

In the goods repository of the goods storage system, the plurality of storage shafts are arranged directly next to one another in a plurality of rows and columns so that there are no aisles, for example for conventional storage and retrieval machines, between any two rows or columns of storage shafts. In the goods repository, the stored containers cannot therefore be laterally removed individually from a storage shaft at any height. Rather, due to the design of the storage shafts arranged directly next to one another, one container or a plurality of containers can only be removed via a shaft opening at the upper end of the corresponding storage shaft. At most, it can optionally be provided that individual containers can be removed at a lower end of the corresponding storage shaft if a lowest level in the goods repository is kept free.

In general, however, in the inventive goods repositories with storage shafts arranged directly next to one another in a plurality of rows and columns, it is provided that one or more containers are removed or inserted via the upper shaft opening.

To allow containers to be removed or inserted via the upper shaft openings of the plurality of storage shafts, a driving level is arranged above the storage shafts on which one or more driverless vehicles can drive in order to be able to automatically get in proximity to a desired shaft opening of a desired storage shaft. The driverless vehicle is designed to transport a container to be placed in the goods repository to the desired shaft opening of a desired storage shaft so that this container can be inserted in the relevant storage shaft. In known goods storage systems, the driverless vehicles have a type of crane device that can lower a transported container into the storage shaft by unrolling at least one cable on the driverless vehicle. In an analogous manner, a container located in the storage shaft can be lifted by winding up at least one cable within the storage shaft in order to be able to remove the container from the storage shaft via the shaft opening. The disadvantage, however, is that only one single, topmost container can be removed from the storage shaft at a time.

Very complex goods storage systems are also known in which each storage shaft has its own lifting apparatus and its own lifting drive for moving the corresponding lifting apparatus. In so doing, although entire container stacks can be lifted or lowered simultaneously within the corresponding storage shaft, this solution requires a large number of lifting drives (one lifting drive per storage shaft) and complex cabling of the electrical lifting drives.

The goods storage system comprises an upper driving level which comprises guides which are designed to drive a driverless vehicle within the driving level, optionally in a first driving direction, in order to be able to switch between a plurality of shaft openings of a plurality of storage shafts arranged in a row, and in a second driving direction in order to be able to switch between a plurality of shaft openings of a plurality of storage shafts arranged in a column.

The driverless vehicle can, for example, be movable in a first driving direction and in a second driving direction perpendicular to the first driving direction in order to be able to switch between a plurality of shaft openings of a plurality of storage shafts arranged in columns and rows. In a modified embodiment, the driverless vehicle can also be driven diagonally, for example.

Accordingly, one or more driverless vehicles automatically drive along the guides on the driving level so that the driverless vehicle can be moved to any desired shaft opening of any storage shaft in the goods repository. This basically serves to allow a container to be transported by the driverless vehicle to a desired shaft opening in order to be able to place this transported container into the storage shaft, or to allow a container to be removed from a desired storage shaft and transported out of the goods repository.

Inventively, it is now proposed that the at least one driverless vehicle comprises a lifting drive, and no stationary lifting drives are present on the goods repository itself.

Although in addition, a plurality of passive, i.e. non-driven, lifting apparatuses arranged on the goods repository are provided on the storage shafts, of which one lifting apparatus is designed to lift and lower at least one stack of a plurality of containers stored in a corresponding storage shaft. However, the plurality of lifting apparatuses are designed without a drive.

Inventively, however, each lifting apparatus or each group of a plurality of lifting apparatuses has a drive coupling which is designed to inject a drive torque into the lifting apparatus, wherein the drive couplings are accessible from the driving level.

The at least one driverless vehicle has a drive mating coupling corresponding to the drive couplings of the lifting apparatuses, which drive mating coupling is designed for automatic coupling to one of the drive couplings of the stationary lifting apparatuses when the driverless vehicle is located in couplable proximity to the corresponding drive coupling of the lifting apparatus. Lifting or lowering containers within a storage shaft by means of the lifting apparatus is namely basically only sensible if a driverless vehicle is located in proximity to the shaft opening of the relevant storage shaft so that at least one relevant container can be transferred. This means that a lifting drive is only required where a driverless vehicle is located. Since the driverless vehicle already comprises a chassis with drives, and the drives of the driverless vehicle must be supplied with drive energy anyway, the same infrastructure for providing the drive energy for the drives can also be used as drive energy for the lifting drive also entrained by the driverless vehicle.

The drive energy can preferably be electrical energy, and the lifting drive also entrained by the driverless vehicle can be an electric lifting drive.

The electrical drive energy can, for example, be stored in a repository for electrical energy also entrained by the driverless vehicle, such as a drive battery. Alternatively, it can be provided that the driverless vehicle comprises an electrical mating plug connector that can be electrically contacted with a stationary plug connector in order to be able to transmit electrical energy to the driverless vehicle by wire. Possibly, a wireless transmission of electrical energy to the driverless vehicle is also possible, for example via induction apparatuses.

The drive mating coupling can be mounted on the driverless vehicle by means of an adjusting device so as to be automatically adjustable between a coupling position in which the drive mating coupling is in engagement with the drive coupling of a lifting apparatus when the driverless vehicle is located in couplable proximity to the corresponding drive coupling of the lifting apparatus, and a release position in which the drive mating coupling is separated from the drive coupling of the lifting apparatus.

In the coupling position in which the drive mating coupling is in engagement with the drive coupling of the lifting apparatuses, a drive torque generated by the lifting drive of the driverless vehicle can be transferred to the stationary lifting apparatus of the storage shaft in the goods repository. The lifting drive controlled by the driverless vehicle controls the lifting apparatus of the desired storage shaft in order to lift or lower a container or a stack of a plurality of containers within the storage shaft.

The drive mating coupling can, for example, comprise a drive profile as is generally known for driving screw heads. This means for example that the drive mating coupling can be designed in the manner of an internal hexagon socket profile, wherein the drive coupling of the lifting apparatus can accordingly comprise an external hexagon socket profile.

The adjusting apparatus can, for example, comprise a lever, a linkage drive and/or a linear drive by means of which at least the drive mating coupling can be lifted and/or lowered in an axial direction to its axis of rotation. The adjusting device can also be designed to lift and/or lower the lifting drive together with the drive mating coupling. For example, the lifting drive can accordingly comprise an electric motor that comprises a motor shaft to which the drive mating coupling is attached. Possibly, the electric motor as such can be fixedly mounted on the driverless vehicle, and only the motor shaft together with the drive mating coupling can be mounted so as to be height-adjustable in an axial direction.

The driverless vehicle can accordingly comprise an electrical energy repository and a lifting drive connected to the electrical energy repository, which lifting drive is designed as an electric motor to the motor shaft of which the drive mating coupling is connected.

The goods storage system can comprise at least one charging station arranged on the goods repository, which charging station is designed and equipped to charge the electrical energy repository of the driverless vehicle, wherein the charging station comprises an electrical plug connector via which electrical energy can be emitted from the charging station, and the driverless vehicle comprises an electrical mating plug connector corresponding to the electrical plug connector of the charging station, wherein the electrical mating plug connector of the driverless vehicle can be electrically coupled to the electrical plug connector of the charging station when the driverless vehicle is located in couplable proximity to the corresponding drive coupling of the lifting apparatus.

The electric motor of the lifting drive can be designed and equipped to draw electrical energy directly from an electrical network to which the charging station is connected when the electrical mating plug connector of the driverless vehicle is coupled state with the electrical plug connector of the charging station. In this case, it can be provided that the electrical energy for driving by means of the drives continues to be obtained from the electrical energy repository of the vehicle.

If the lifting drive of the driverless vehicle is connected to the drive coupling of a lifting apparatus by means of its drive mating coupling, the driverless vehicle is at a standstill, i.e. the driverless vehicle does not drive. Accordingly, during such a standstill of the driverless vehicle, it is not necessary for electrical energy to be drawn from the electrical energy repository of the driverless vehicle. Rather, the driverless vehicle at a standstill can be connected to a stationary electrical plug connector by means of its mating plug connector so that the electrical energy can be obtained from outside the driverless vehicle, in particular from an electrical network, via the electrical contacting of the mating plug connector and the plug connector. While the lifting drive is supplied with electrical energy from a network in order to drive one of the lifting apparatuses, the electrical energy repository of the driverless vehicle, in particular a drive battery of the driverless vehicle, can possibly also be charged with electrical energy in parallel.

The corresponding drive coupling of the lifting apparatus can be connected to a lifting spindle which extends along the height of at least one storage shaft, wherein a platform for depositing containers which extends into the storage shaft is mounted on the lifting spindle in a height-adjustable manner such that by driving the lifting spindle via the drive coupling, the platform can be lifted within the storage shaft in order to be able to lift the containers deposited in a stack on the platform upwards out of the storage shaft via the shaft opening, and/or can be lowered in order to be able to lower the containers deposited in a stack on the platform into the shaft opening and downwards into the storage shaft.

Each storage shaft can comprise its own lifting apparatus. Alternatively, two storage shafts or a group of a plurality of storage shafts can also comprise a common lifting apparatus. In the case of a common lifting apparatus, a plurality of containers in different storage shafts can be lifted and/or lowered together using a single lifting drive.

A lifting apparatus can comprise at least one lifting spindle. The lifting spindle can extend over the entire height of the storage shaft or at least substantially over the basic height of the storage shaft. A single lifting spindle can be provided per storage shaft. Alternatively, two or more lifting spindles can be provided per storage shaft. If the storage shaft only comprises a single lifting spindle, the lifting apparatus can additionally comprise guides, such as stationary rods, which extend parallel to the lifting spindle over the basic height of the storage shaft. A height-adjustable platform is coupled to the at least one lifting spindle so that by driving the lifting spindle via the drive coupling, the platform can be lifted within the storage shaft in order to be able to lift the containers deposited in a stack on the platform upwards out of the storage shaft via the shaft opening, and/or can be lowered in order to be able to lower the containers deposited in a stack on the platform into the shaft opening and downwards into the storage shaft. The platform can possibly also be guided in a height-adjustable manner on the optionally available guides or rods.

In a simple embodiment, the drive coupling can be formed by a corresponding drive profile which is on an upper end portion of the lifting spindle. The drive coupling can therefore be designed as a single piece with the lifting spindle.

The platform can comprise at least one through hole that is provided with an internal spindle thread. The lifting spindle bears an external spindle thread which engages in the internal spindle thread of the through hole through which the lifting spindle is guided. By rotating the lifting spindle in one direction of rotation, the platform is accordingly lifted, and by rotating the lifting spindle in the opposite direction of rotation, the platform is accordingly lowered. One or more containers that are deposited on the platform within the storage shaft can be also lifted and/or lowered by lifting or lowering the platform. The platform therefore extends transversely across the cross section of the storage shaft. The platform can, for example, be formed by a closed-surface plate, a grid or, for example, by fork-like individual tines.

The corresponding drive coupling of the lifting apparatus can be connected to a lifting spindle which extends along the height of at least one storage shaft, wherein at least one auxiliary lifting spindle extends along the storage shaft, which auxiliary lifting spindle can be driven together with the lifting spindle, wherein the lifting spindle and the auxiliary lifting spindle are arranged opposite the stack of containers in the storage shaft, and each comprise a spindle thread which is designed to engage support portions on lateral edge regions of the containers such that containers engaging in the spindle threads of the lifting spindle and the auxiliary lifting spindle can be lifted and/or lowered individually by rotating the lifting spindle and the auxiliary lifting spindle. In such a stack, it can be provided that two containers arranged directly one above the another do not sit directly on top of one another, but are slightly spaced apart from one another since each container is independently supported on the lifting spindle and the auxiliary lifting spindle. Within the scope of the invention, such spaced arrangements of stacks are nevertheless referred to as a stack, in the sense that the plurality of containers are arranged one above the other within a single storage shaft.

Each container can comprise a support portion on two opposite sides. The corresponding support portion can be designed as a single piece with the container. The container can, for example, be made of plastics material.

Each support portion can, for example, comprise a strip-like projection that is arranged on the side wall of the container in an oblique orientation that corresponds to the pitch angle of the corresponding spindle thread of the lifting spindle and the auxiliary lifting spindle. In this embodiment, the support portions of the container therefore engage in the spindle threads of the lifting spindle and the auxiliary lifting spindle. Accordingly, each container is suspended at a specific height on the lifting spindle and the auxiliary lifting spindle. By rotating the lifting spindle and the auxiliary lifting spindle, the support portions engaging in the spindle threads optionally move upwards or downwards depending on the direction of rotation so that the suspended container in the storage shaft is correspondingly lifted or lowered.

The support portions of the containers can possibly be adjustable so that they can be optionally brought into engagement with the lifting spindle and the auxiliary lifting spindle so that the relevant container can be lifted and/or lowered by rotating the lifting spindle and the auxiliary lifting spindle, or the support portions of the containers can be disengaged so that such a container is not also moved during a rotation of the lifting spindle and the auxiliary lifting spindle.

The lifting spindles and the auxiliary lifting spindles can end at a vertical height above the floor of the goods repository, which is at least as high as the height of a container so that the containers guided by the lifting spindles and the auxiliary lifting spindles can be released from engagement with the spindle threads of the lifting spindles and auxiliary lifting spindles at a height position close to the floor in order to be able to eject a corresponding container released from the lifting spindles and auxiliary lifting spindles from the goods repository at a lower level.

In this embodiment, the lifting spindles and the auxiliary lifting spindles do not extend into the lowest level of the goods repository. Containers released downwards can possibly be transported out of the goods repository on the lower level by ground-based vehicles or, for example, by means of active or passive conveying devices such as roller conveyors or conveyor belts. In an analogous manner, a container to be placed into the goods repository can be automatically transported by the ground-based vehicle within the lowest level below the storage shafts to the bottom side of a specific storage shaft. Once the container has arrived under the selected storage shaft, the container can be lifted into the storage shaft from below, for example by a lifting apparatus, and picked up there by the lifting spindle and the auxiliary lifting spindle so that the picked up container can be automatically lifted and lowered again within the storage shaft by means of the lifting apparatus.

Each storage shaft can have an at least substantially rectangular cross section, two or four storage shafts can each form a quadrant on the driving level with their shaft openings, wherein the two or four lifting spindles assigned to the two or four storage shafts are arranged close to the center of the quadrant such that, in a view from above, the storage shaft arranged in the first quadrant has its first lifting spindle in the lower left corner, the storage shaft arranged in the second quadrant has its second lifting spindle in the lower right corner, the storage shaft arranged in the third quadrant has its third lifting spindle in the upper right corner, and/or the storage shaft arranged in the fourth quadrant has its fourth lifting spindle in the upper left corner.

This means that a group of four directly adjacent storage shafts can have their corresponding lifting spindles arranged close to the center. This has the advantage that a driverless vehicle can optionally drive one of the four lifting spindles from a certain position on the driving level by means of the lifting drive of the driverless vehicle without the driverless vehicle having to leave or change its current vehicle position. Possibly, the driverless vehicle can also comprise more than just a single lifting drive so that in such an embodiment, two, three or four lifting spindles of the four different storage shafts can possibly be moved simultaneously. Accordingly, containers can be lifted or lowered in up to four storage shafts simultaneously. Of course, it can also be provided that, for example, a container or a group of containers in a first storage shaft are lifted, whereas a container or a group of containers in a second storage shaft, which is different from the first storage shaft, are lowered at the same time.

The driverless vehicle can comprise at least one support arm which is designed to receive at least one container or a stack of a plurality of containers simultaneously in order to be able to transport them together within the driving level.

In a first embodiment variant, the support arm can extend laterally from a cuboid base casing of the driverless vehicle so that a container can be removed from a storage shaft or can be inserted into said storage shaft which is arranged directly next to the storage shaft above which the driverless vehicle is located.

In a second embodiment variant, the driverless vehicle can comprise a frame-like structure which has a passage opening in the center through which containers can be removed from the storage shaft through the frame-like structure of the driverless vehicle, and/or containers can be inserted into the storage shaft. In such an embodiment variant, a support arm can accordingly extend inwards, starting from the frame-like outer structure in the direction of the center into the passage opening so that the support arm can place a container or a stack of a plurality of containers centrally above the shaft opening above which the driverless vehicle is currently located.

The object is also achieved by a method for lifting and/or lowering at least one container or a stack of a plurality of containers within a storage shaft in a goods repository of a goods storage system, in particular a goods storage system as described, comprising the steps:
automatically driving a driverless vehicle which is designed and equipped to automatically drive on a driving level above storage shafts of the goods repository along guides in the driving level so that the driverless vehicle can be moved to an upper shaft opening of any storage shaft of the goods repository by the driverless vehicle being driven in a self-driven manner optionally in the first driving direction and/or in the second driving direction along the guides,
automatically coupling a drive mating coupling of the driverless vehicle, which can be driven by a lifting drive of the driverless vehicle, to a drive coupling of a lifting apparatus of the goods repository arranged stationary in the relevant storage shaft such that a torque can be transmitted by the lifting drive of the driverless vehicle to the lifting apparatus of the goods repository in order to be able to optionally lift or lower a container present in the storage shaft or a stack of a plurality of containers present in the storage shaft by means of the lifting apparatus,
automatically driving the lifting drive of the driverless vehicle in order to lift or lower the container present in the storage shaft or the stack of a plurality of containers present in the storage shaft by means of the lifting apparatus.

In such a stack, it can also be provided within the scope of the method that two containers arranged directly one above the another do not sit directly on top of one another, but are slightly spaced apart from one another since each container is independently supported on the lifting spindle and the auxiliary lifting spindle. Within the scope of the invention, such spaced arrangements of stacks are nevertheless referred to as a stack, in the sense that the plurality of containers are arranged one above the other within a single storage shaft.

The method can comprise the further step of automatically drawing electrical energy from a stationary charging station of the goods repository into an electrical energy repository of the driverless vehicle and/or into the lifting drive of the driverless vehicle, while the lifting drive of the driverless vehicle drives the lifting apparatus of the goods repository for lifting or lowering a container present in the storage shaft or the stack of a plurality of containers present in the storage shaft.

Specific embodiments of the invention are explained in more detail in the following description with reference to the accompanying drawings. Specific features of these embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic representation of a section of an exemplary inventive goods storage system with lifting apparatuses in the form of lifting spindles and a driverless vehicle with a cantilevered support arm for containers,

FIG. 2 is a schematic representation of a section of an exemplary inventive goods storage system with lifting apparatuses in the form of lifting spindles and a driverless vehicle with a frame-like external structure,

FIG. 3 is a schematic representation of a section of an exemplary inventive goods storage system of a second embodiment with lifting apparatuses in the form of lifting spindles and auxiliary lifting spindles on which containers are directly held,

FIG. 4 is a side view of a section of an exemplary inventive goods storage system of a third embodiment with a plurality of lifting apparatuses in a common corner region of a group of four storage shafts,

FIG. 5 is a plan view of the third embodiment of the goods storage system according to FIG. 4, and

FIG. 6 is a flow chart of the steps in a basic exemplary inventive method.

### DETAILED DESCRIPTION

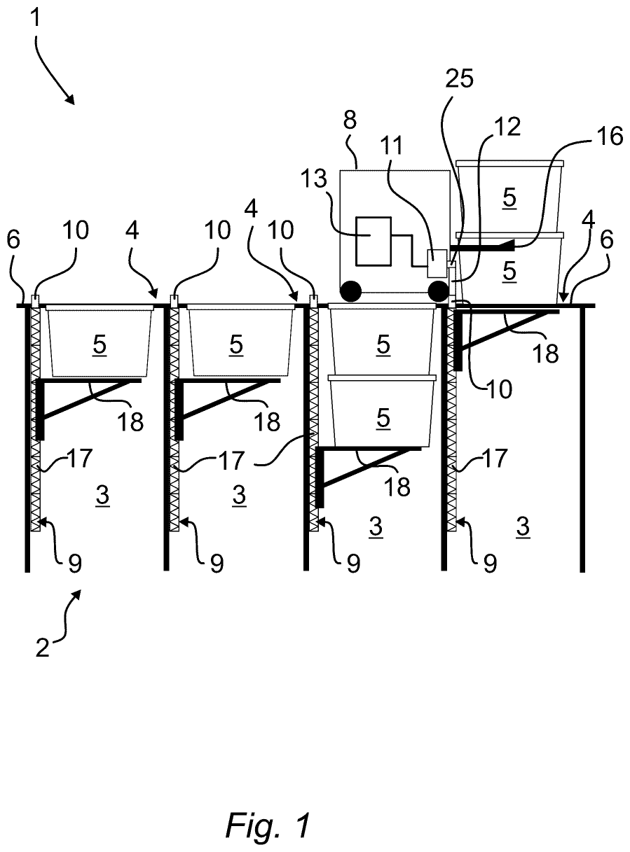

In FIG. 1, an exemplary goods storage system 1 is schematically shown.

The goods storage system 1 has a goods repository 2 that comprises a plurality of storage shafts 3 arranged in a plurality of rows and columns directly next to one another such that each storage shaft 3 is accessible via an upper shaft opening 4 for removing one or more containers 5 from the corresponding storage shaft 3 from above, and/or for inserting one or more containers 5 into the corresponding storage shaft 3 from above so that a plurality of containers 5 can be stored in a vertical stack within the corresponding storage shaft.

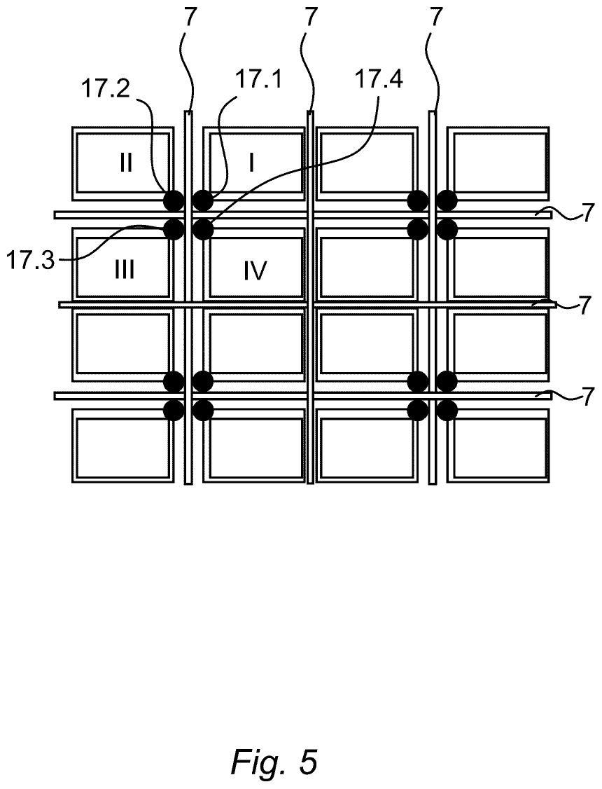

The goods storage system 1 comprises a driving level 6 arranged above the storage shafts 3, which comprises guides 7 (FIG. 5) which are designed to drive a driverless vehicle 8 within the driving level 6, optionally in a first driving direction, in order to be able to switch between a plurality of shaft openings 4 of a plurality of storage shafts 3 arranged in a row, and in a second driving direction in order to be able to switch between a plurality of shaft openings 4 of a plurality of storage shafts 3 arranged in a column.

The goods storage system 1 accordingly has at least one driverless vehicle 8 which is designed and equipped to automatically drive in the driving level 6 along the guides 7 so that the driverless vehicle 8 can be moved to the shaft opening 4 of any storage shaft 2 of the goods repository 2 by the driverless vehicle 8 driving in a self-driven manner optionally in the first driving direction and/or in the second driving direction along the guides 7.

The goods storage system 1 comprises a plurality of lifting apparatuses 9 arranged on the goods repository 2, of which one lifting apparatus 9 is designed to lift and lower at least one stack of a plurality of containers 5 stored in a corresponding storage shaft 3.

The plurality of lifting apparatuses 9 are designed without a drive, and each lifting apparatus 9 or a corresponding group of a plurality of lifting apparatuses 9 has a drive coupling 10 which is designed to inject a drive torque into the lifting apparatus 9, wherein the drive couplings 10 are accessible from the driving level 6.

Inventively, the at least one driverless vehicle 8 has a lifting drive 11 with a drive mating coupling 12 corresponding to the drive couplings 10 of the lifting apparatuses 9, which drive mating coupling is designed for automatic coupling to one of the drive couplings 10 of the lifting apparatuses 9 when the driverless vehicle 8 is located in couplable proximity to the corresponding drive coupling 10 of the lifting apparatus 9.

In the case of the present embodiment, the drive mating coupling 12 is mounted on the driverless vehicle 8 by means of an adjusting apparatus 25 so as to be automatically adjustable between a coupling position in which the drive mating coupling 12 is in engagement with the drive coupling 10 of a lifting apparatus 9 when the driverless vehicle 8 is located in couplable proximity to the corresponding drive coupling 10 of the lifting apparatus 9, and a release position in which the drive mating coupling 12 is separated from the drive coupling 10 of the lifting apparatus 9.

In the case of the present embodiments, the driverless vehicle 8 has an electrical energy repository 13. The lifting drive 11 is designed as an electric motor, to the motor shaft of which the drive mating coupling 12 is connected, wherein the lifting drive 11, i.e. the electric motor, is connected to the electrical energy repository 12.

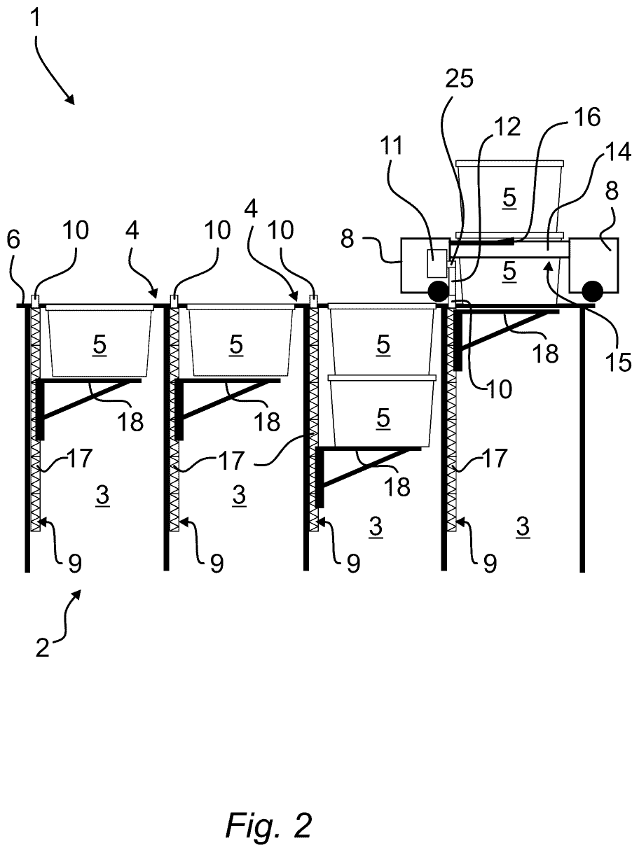

In an embodiment variant according to FIG. 2, the driverless vehicle 8 can comprise a frame-like structure 14 which comprises a passage opening 15 in the center through which containers 5 can be removed from the storage shaft 3 through the frame-like structure 14 of the driverless vehicle 8, and/or containers 5 can be inserted into the storage shaft 3. In such an embodiment variant, a support arm 16 can accordingly extend inwards, starting from the frame-like outer structure 14 in the direction of the center into the passage opening 15 so that the support arm 16 can place a container 5 or a stack of a plurality of containers 5 centrally above the shaft opening 4 above which the driverless vehicle 8 is currently located.

In the embodiments according to FIG. 1 and FIG. 2, the corresponding drive coupling 10 of the lifting apparatus 9 is connected to a lifting spindle 17 which extends along the height of at least one storage shaft 3, wherein a platform 18 for depositing containers 5 which extends into the storage shaft 3 is mounted on the lifting spindle 17 in a height-adjustable manner such that by driving the lifting spindle 17 via the drive coupling 10, the platform 18 can be lifted within the storage shaft 3 in order to be able to lift the containers 5 deposited in a stack on the platform 18 upwards out of the storage shaft 3 via the shaft opening 4, and/or can be lowered in order to be able to lower the containers 5 deposited in a stack on the platform 18 into the shaft opening 4 and downwards into the storage shaft 3.

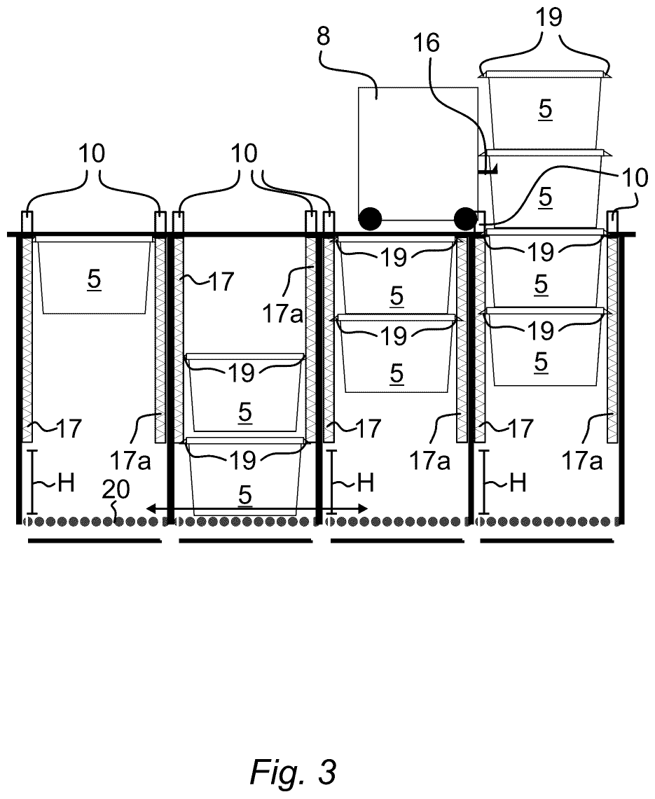

FIG. 3 shows a modified embodiment in which the corresponding drive coupling 10 of the lifting apparatus 9 is connected to a lifting spindle 17 which extends along the height of at least one storage shaft 3, wherein at least one auxiliary lifting spindle 17a also extends along the storage shaft 3, which auxiliary lifting spindle can be driven together with the lifting spindle 17, wherein the lifting spindle 17 and the auxiliary lifting spindle 17a are arranged opposite the stack of containers 5 in the storage shaft 3 and each comprise a spindle thread which is designed to engage support portions 19 on lateral edge regions of the containers 5, such that containers 5 engaging in the spindle threads of the lifting spindle 17 and the auxiliary lifting spindle 17a can be lifted and/or lowered individually by rotating the lifting spindle 17 and the auxiliary lifting spindle 17a.

In the case of the shown embodiment in FIG. 3, the lifting spindles 17 and the auxiliary lifting spindles 17a end at a vertical height H above the floor 20 of the goods repository 2, which is at least as high as the height of a container 5 so that the containers 5 guided by the lifting spindles 17 and the auxiliary lifting spindles 17a can be released from engagement with the spindle threads of the lifting spindles 17 and auxiliary lifting spindles 17a at a height position close to the floor in order to be able to eject a corresponding container 5 released from the lifting spindles 17 and auxiliary lifting spindles 17a from the goods repository 2 at a lower level.

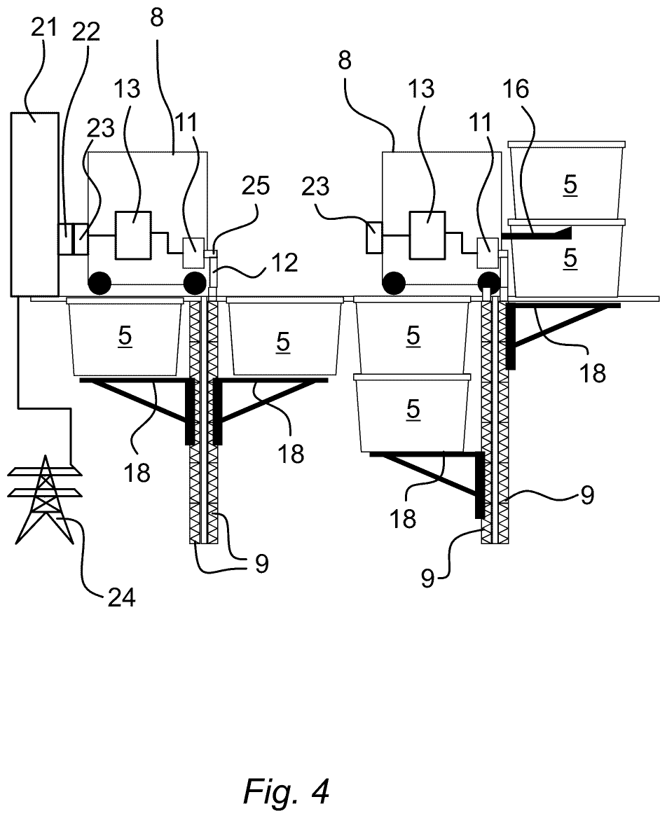

As shown schematically in FIG. 4, the goods storage system 1 can comprise at least one charging station 21 arranged on the goods repository 2, which charging station is designed and equipped to charge the electrical energy repository 13 of the driverless vehicle 8, in the case of FIG. 4 the vehicle 8 shown on the left, wherein the charging station 21 comprises an electrical plug connector 22 via which electrical energy can be emitted from the charging station 21, and the driverless vehicle 8 comprises an electrical mating plug connector 23 corresponding to the electrical plug connector 22 of the charging station 21, wherein the electrical mating plug connector 23 of the driverless vehicle 8 can be electrically coupled to the electrical plug connector 22 of the charging station 21 when the driverless vehicle 8 is located in couplable proximity to the corresponding drive coupling 10 of the lifting apparatus 9, as shown by the driverless vehicle 8 shown on the left in FIG. 4.

The electric motor of the lifting drive 9 can be designed and equipped to draw electrical energy directly from an electrical network 24 to which the charging station 21 is connected when the electrical mating plug connector 23 of the driverless vehicle 8 is coupled to the electrical plug connector 22 of the charging station 21.

As shown in particular in FIG. 5 in conjunction with FIG. 4, in such an embodiment each storage shaft 3 can have an at least substantially rectangular cross section, four storage shafts 3 can form a quadrant on the driving level 6 with their shaft openings 4, wherein the four lifting spindles 17 assigned to the four storage shafts 3 are arranged close to the center of the quadrant such that, in a view from above, the storage shaft 3 arranged in the first quadrant I has its first lifting spindle 17.1 in the lower left corner, the storage shaft 3 arranged in the second quadrant II has its second lifting spindle 17.2 in the lower right corner, the storage shaft 3 arranged in the third quadrant Ill has its third lifting spindle 17.3 in the upper right corner and the storage shaft 3 arranged in the fourth quadrant IV has its fourth lifting spindle 17.4 in the upper left corner.

In all embodiments, the driverless vehicle 8 can comprise at least one support arm 16 which is designed to receive at least one container 5 or a stack of a plurality of containers 5 simultaneously in order to be able to transport them together within the driving level 6.

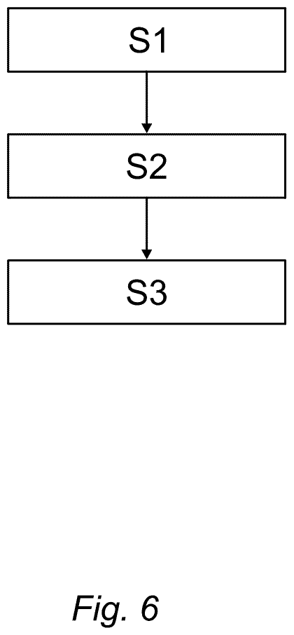

FIG. 6 schematically shows an exemplary method for lifting and/or lowering at least one container 5 or a stack of a plurality of containers 5 within a storage shaft 3 in a goods repository 2 of a goods storage system 1.

In a first step S1 of the method, a driverless vehicle 8 is automatically driven which is designed and equipped to automatically drive on a driving level 6 above storage shafts 3 of the goods repository 2 along guides 7 in the driving level 6 so that the driverless vehicle 8 can be moved to an upper shaft opening 4 of any storage shaft 3 of the goods repository 2 by the driverless vehicle 8 being driven in a self-driven manner optionally in the first driving direction and/or in the second driving direction along the guides 7.

In a second step S2 of the method, a drive mating coupling 12 of the driverless vehicle 8 which can be driven by a lifting drive 11 of the driverless vehicle 8 is automatically coupled to a drive coupling 10 of a lifting apparatus 9 of the goods repository 2 arranged stationary in the relevant storage shaft 3 such that a torque can be transmitted by the lifting drive 11 of the driverless vehicle 8 to the lifting apparatus 9 of the goods repository 2 in order to be able to optionally lift or lower a container 5 present in the storage shaft 3 or a stack of a plurality of containers 5 present in the storage shaft 3 by means of the lifting apparatus 9.

In a third step S3 of the method, the lifting drive 11 of the driverless vehicle 8 is automatically driven in order to lift or lower the container 5 present in the storage shaft 3 or the stack of a plurality of containers 5 present in the storage shaft 3 by means of the lifting apparatus 9.

In an optional further step of the method, electrical energy can be automatically drawn from a stationary charging station 21 of the goods repository 1 into an electrical energy repository 13 of the driverless vehicle 8 and/or into the lifting drive 11 of the driverless vehicle 8, while the lifting drive 11 of the driverless vehicle 8 drives the lifting apparatus 9 of the goods repository 2 for lifting or lowering a container 5 present in the storage shaft 3 or the stack of a plurality of containers 5 present in the storage shaft 3.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A goods storage system (1), comprising:
a goods repository (2) that comprises a plurality of storage shafts (3) arranged in a plurality of rows and columns directly next to one another such that each storage shaft (3) is accessible via an upper shaft opening (4) for removing one or more containers (5) from the corresponding storage shaft (3) from above and/or for inserting one or more containers (5) into the corresponding storage shaft (3) from above, so that a plurality of containers (5) can be stored in a vertical stack within the corresponding storage shaft (3),
a driving level (6) arranged above the storage shafts (3), which comprises guides (7) which are designed to drive a driverless vehicle (8) within the driving level (6), optionally in a first driving direction, in order to be able to switch between a plurality of shaft openings (4) of a plurality of storage shafts (3) arranged in a row, and in a second driving direction in order to be able to switch between a plurality of shaft openings (4) of a plurality of storage shafts (3) arranged in a column,
at least one driverless vehicle (8) which is designed and equipped to automatically drive in the driving level (6) along the guides (7) so that the driverless vehicle (8) can be moved to the shaft opening (4) of any storage shaft (3) of the goods repository (2) by the driverless vehicle (8) driving in a self-driven manner optionally in the first driving direction and/or in the second driving direction along the guides (7),
a plurality of lifting apparatuses (9) arranged on the goods repository (2), of which a lifting apparatus (9) is designed to lift and lower at least one stack of a plurality of containers (5) stored in a corresponding storage shaft (3), characterized in that
the plurality of lifting apparatuses (9) are designed without a drive and each lifting apparatus (9) or a corresponding group of a plurality of lifting apparatuses (9) comprises a drive coupling (10) which is designed to inject a drive torque into the lifting apparatus (9), wherein the drive couplings (10) are accessible from the driving level (6), and in that
the at least one driverless vehicle (8) comprises a lifting drive (11) with a drive mating coupling (12) corresponding to the drive couplings (10) of the lifting apparatuses (9), which drive mating coupling is designed for automatic coupling to one of the drive couplings (10) of the lifting apparatuses (9) when the driverless vehicle (8) is located in couplable proximity to the corresponding drive coupling (10) of the lifting apparatus (9).

2-12. (canceled)
